(19) United States
(12) Patent Application Publication
(10) Pub. No.: US 2023/0237931 A1
(43) Pub. Date: Jul. 27, 2023

(54) VEIN SIMULATOR

(71) Applicant: Becton, Dickinson and Company, Franklin Lakes, NJ (US)

(72) Inventors: Dorien Butter, Millcreek, UT (US); John Lackey, West Valley City, UT (US); Benjamin Parker Hopwood, Salt Lake City, UT (US); Ralph L. Sonderegger, Farmington, UT (US); S. Ray Isaacson, Layton, UT (US); Weston F. Harding, Lehi, UT (US)

(21) Appl. No.: 18/094,737

(22) Filed: Jan. 9, 2023

Related U.S. Application Data
(60) Provisional application No. 63/302,416, filed on Jan. 24, 2022.

(51) Int. Cl. G09B 23/28; G09B 23/30

(52) U.S. Cl. CPC G09B 23/285; G09B 23/30

(57) ABSTRACT

A vein simulator can enable a clinician to perform a PIVC workflow. This workflow can include preparation of simulated skin, insertion of a PIVC into a simulated vein, flushing a line of the PIVC and dressing and securing the PIVC to the simulated skin. The vein simulator may be formed of simulated tissue, simulated skin that is integrated into the simulated tissue and an embedded simulated vein that may be positioned within a protruding vein channel. Because the simulated skin is integrated into the simulated tissue, the vein simulator will provide a more realistic experience while practicing the workflow. A vein simulator may include one or more sensors to provide real-time feedback to a clinician while practicing the workflow.

### RELATED APPLICATIONS

This application claims the benefit of U.S. Provisional Patent Application No. 63/302,416, filed Jan. 24, 2022, and entitled VEIN SIMULATOR, which is incorporated herein in its entirety.

### BACKGROUND

When clinicians such as nursing students graduate, they typically have a minimal level of proficiency in placing peripheral intravenous catheters (PIVCs) and are expected to gain proficiency on the job. A problem with this approach is that an inexperienced clinician will oftentimes require multiple attempts to successfully place a PIVC—an experience that is not pleasant for the patient. To minimize negative experiences, many facilities limit the number of failed attempts an inexperienced clinician can make. After the inexperienced clinician reaches the maximum allowed number of failed attempts (e.g., two), an experienced clinician will be required to place the PIVC.

Some vein simulators have been developed to allow inexperienced clinicians to improve their proficiency in placing PIVCs. Such vein simulators are oftentimes in the form of a fake arm containing a tube through which red fluid is pumped. These vein simulators may be made of materials that respond similar to human skin and veins and may therefore allow an inexperienced clinician to learn how it should feel when the needle pierces the vein during placement of a PIVC. However, these vein simulators do not provide useful guidance for teaching the inexperienced clinician when he or she has properly or improperly placed the PIVC.

The subject matter claimed herein is not limited to embodiments that solve any disadvantages or that operate only in environments such as those described above. Rather, this background is only provided to illustrate one example technology area where some implementations described herein may be practiced.

### SUMMARY

The present disclosure relates generally to a vein simulator that can be used by clinicians to improve their proficiency in performing a PIVC workflow. This workflow can include preparation of simulated skin, insertion of a PIVC into a simulated vein, flushing a line of the PIVC and dressing and securing the PIVC to the simulated skin. The vein simulator may be formed of simulated tissue, simulated skin that is integrated into the simulated tissue and an embedded simulated vein that may be positioned within a protruding vein channel. Because the simulated skin is integrated into the simulated tissue, the vein simulator will provide a more realistic experience while practicing the workflow. A vein simulator may include one or more sensors to provide real-time feedback to a clinician while practicing the workflow.

In some embodiments of the present disclosure, a vein simulator may include simulated skin, simulated tissue into which the simulated skin is integrated and one or more simulated veins that are embedded into the simulated tissue.

In some embodiments, the simulated skin may be leather or artificial leather. In some embodiments, the simulated tissue may be a ballistic gel. In some embodiments, the one or more simulated veins may be a tubular elastomeric material.

In some embodiments, the simulated skin may be integrated into the simulated tissue by causing the simulated tissue to solidify while in contact with the simulated skin. In some embodiments, the simulated skin may include a protruding vein channel. In some embodiments, a first simulated vein of the one or more simulated veins may extend along the protruding vein channel.

In some embodiments, an inner section of the simulated skin may be integrated into the simulated tissue and end portions of the simulated skin may not be integrated into the simulated tissue. In some embodiments, the end portions of the simulated skin may include one or more fasteners for interconnecting the end portions.

In some embodiments, the vein simulator may include one or more cameras for capturing images or video of the simulated tissue or the one or more simulated veins. In some embodiments, the vein simulator may include one or more sensors for providing feedback indicative of a location of a needle relative to the one or more simulated veins.

In some embodiments of the present disclosure, a method for creating a vein simulator may include: obtaining a mold; positioning a simulated skin in the mold; positioning one or more simulated veins in the mold overtop the simulated skin; and adding simulating tissue to the mold on top of the simulated skin.

In some embodiments, positioning the one or more simulated veins in the mold overtop the simulated skin may include inserting a first simulated vein of the one or more simulated veins through openings in the mold.

In some embodiments, the simulated skin may be positioned in the mold on an inner surface and the inner surface may include a channel for forming a protruding vein channel in the simulated skin. In some embodiments, the inner surface may be curved.

In some embodiments, the method may include positioning one or more cameras in or against the simulated tissue.

In some embodiments of the present disclosure, a vein simulator may include simulated skin that is formed of leather or an artificial leather, simulated tissue that is formed of a ballistic gel, the simulated skin being integrated into the simulated tissue, and a simulated vein that is embedded in the simulated tissue.

In some embodiments, the simulated skin and the simulated tissue may form a protruding vein channel and the simulated vein may extend along the protruding vein channel.

In some embodiments, the simulated skin may be configured to secure the vein simulator to a manikin.

In some embodiments, the vein simulator may include one or more cameras for capturing images or videos inside the vein simulator.

It is to be understood that both the foregoing general description and the following detailed description are examples and explanatory and are not restrictive of the invention, as claimed. It should be understood that the various embodiments are not limited to the arrangements and instrumentality shown in the drawings. It should also be understood that the embodiments may be combined, or that other embodiments may be utilized and that structural changes, unless so claimed, may be made without departing from the scope of the various embodiments of the present invention. The following detailed description is, therefore, not to be taken in a limiting sense.

### BRIEF DESCRIPTION OF THE SEVERAL VIEWS OF THE DRAWINGS

Example embodiments will be described and explained with additional specificity and detail through the use of the accompanying drawings in which:

FIGS. 1A and 1B are views of a vein simulator that is configured in accordance with one or more embodiments of the present disclosure when the vein simulator is placed on a manikin's forearm;

FIG. 2 is a view of a mold that may be used to create a vein simulator in accordance with one or more embodiments of the present disclosure;

FIGS. 3A-3D provide an example of how a vein simulator may be created using the mold of FIG. 2 in accordance with one or more embodiments of the present disclosure;

FIGS. 4A and 4B are cross-sectional views of a vein simulator that is configured in accordance with one or more embodiments of the present disclosure and represent how one or more cameras may be integrated into or used with the vein simulator; and

FIGS. 5A and 5B are cross-sectional views of a vein simulator that is configured in accordance with one or more embodiments of the present disclosure and represent how one or more sensors may be integrated into or used with the vein simulator.

### DESCRIPTION OF EMBODIMENTS

A vein simulator that is configured in accordance with one or more embodiments of the present disclosure enables a clinician to perform a PIVC workflow. This workflow can include preparation of simulated skin, insertion of a PIVC into a simulated vein, flushing a line of the PIVC and dressing and securing the PIVC to the simulated skin. The vein simulator may be formed of simulated tissue, simulated skin that is integrated into the simulated tissue and an embedded simulated vein that may be positioned within a protruding vein channel. Because the simulated skin is integrated into the simulated tissue, the vein simulator will provide a more realistic experience while practicing the workflow.

A vein simulator that is configured in accordance with one or more embodiments of the present disclosure can also employ one or more sensors to provide feedback to a clinician during the process of placing a PIVC. Different types of sensors may be employed to provide different types of feedback. For example, a camera may be employed to provide visual (e.g., video) feedback of the advancement of the PIVC within a simulated vein. As another example, a film, such as a conductive or capacitive material, may be included on, within or near a simulated vein to provide visual and/or audio feedback representing the position of the PIVC within a simulated vein.

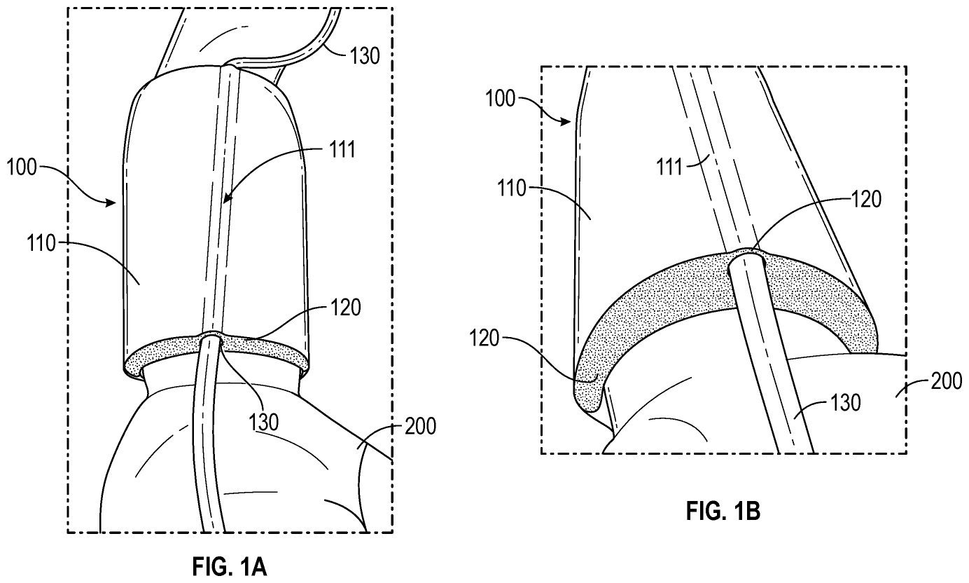

FIGS. 1A and 1B provide an example of a vein simulator 100 that is configured in accordance with one or more embodiments of the present disclosure when vein simulator 100 is positioned on the forearm of a manikin 200. Vein simulator 100 includes simulated skin 110 that is positioned overtop of and integrated into simulated tissue 120 and a simulated vein 130 (or multiple simulated veins) that are embedded in simulated tissue 120. In some embodiments, simulated vein 130 can extend along a protruding vein channel 111. In other words, simulated skin 110 can protrude overtop of simulated vein 130 in a similar manner as veins cause human skin to protrude.

In some embodiments, including the depicted embodiment, vein simulator 100 can be in the form of a band that may be wrapped around and secured to a portion of manikin 200. For example, the length of simulated skin 110 can be sufficient to wrap around the forearm of manikin 200 and can then be secured together to retain vein simulator 100 in place on the forearm. In other embodiments, a vein simulator can be shaped and/or sized for a different location of manikin 200 such as the elbow, hand, neck, feet, etc. In some embodiments, a vein simulator may be integrated into a manikin or other representation of the human anatomy. In some embodiments, vein simulator 100 may not be used with a manikin. For example, vein simulator 100 could be formed to resemble a portion of the human anatomy (e.g., the forearm) and may be used in isolation.

In embodiments where vein simulator 100 is used on or integrated into manikin 200, manikin 200 can provide a more realistic experience for the clinician. For example, by positioning vein simulator 100 on the forearm of manikin 200, the clinician will be better able to visualize inserting a PIVC on a human's forearm including using manikin 200 to provide landmarks that are analogous to the human anatomy. Also, the clinician will need to maneuver around manikin 200 thereby training the clinician to better maneuver around patients.

In some embodiments, simulated skin 110 may be formed of leather, artificial leather or another human skin analogue. By forming simulated skin 110 of such human skin analogues, simulated skin 110 can be cleaned and prepared in the same manner as human skin. Also, human skin analogues can cause simulated skin 110 to provide a similar feel as human skin when a clinician inserts a PIVC. Additionally, the thickness of simulated skin 110 can be selected to require a clinician to apply a desired amount of force to place a PIVC. Further, human skin analogues enable dressings to be applied to simulated skin 110 after insertion of a PIVC such as to secure the PIVC in place on simulated skin 110. Simulated skin 110 of different tones can also be used.

In some embodiments, simulated tissue 120 may be a ballistic material, medical gel or other gel that is selected to provide a desired firmness to thereby approximate human tissue. In some embodiments, simulated tissue 120 may be clear to facilitate the use of cameras as described below. In some embodiments, one or more rigid support structures (e.g., dowels, wire, 3D printed bone-like structures, etc.) may be integrated into simulated tissue 120 to mimic human bones, tendons, ligaments, etc. In some embodiments, simulated vein 130 may be formed of silicone, latex, polyurethane, or any other tubular, elastomeric material.

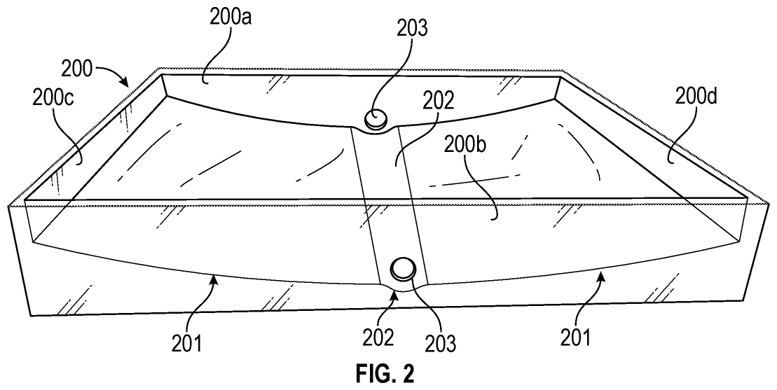

FIG. 2 shows a mold 200 that can be used to create vein simulator 100 in one or more embodiments of the present disclosure. Mold 200 can include an upwardly oriented inner surface 201 that is surrounded by walls 200a-200d. In some embodiments, inner surface 201 may be curved to mimic the shape of the human forearm. In other embodiments, inner surface 201 could have a shape and/or curvature that resembles another portion of the human anatomy such as the elbow, hand, neck, feet, etc.

A channel 202 may be formed in inner surface 201 and may be positioned, sized and shaped to generally correspond with the intended position, size and shape of simulated vein 130. Opposing openings 203 may be formed in walls 200a and 200b slightly above channel 202 and may be used to retain simulated vein 130 in place over channel 202 while simulated tissue 120 is added. Notably, openings 203 may be used to control the depth of simulated vein 130 (i.e., the distance between simulated skin 110 and simulated vein 130) and can ensure that some of simulated tissue 120 will be positioned between simulated skin 110 and simulated vein 130.

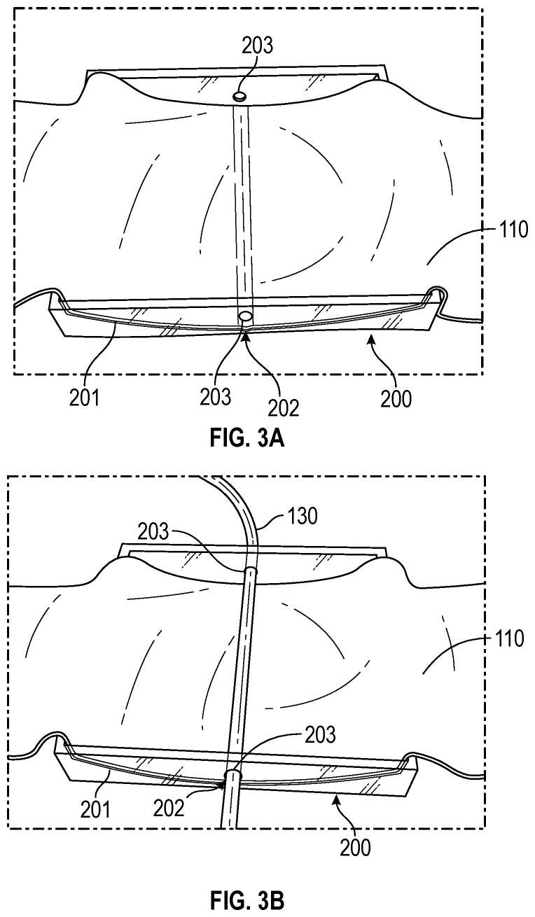

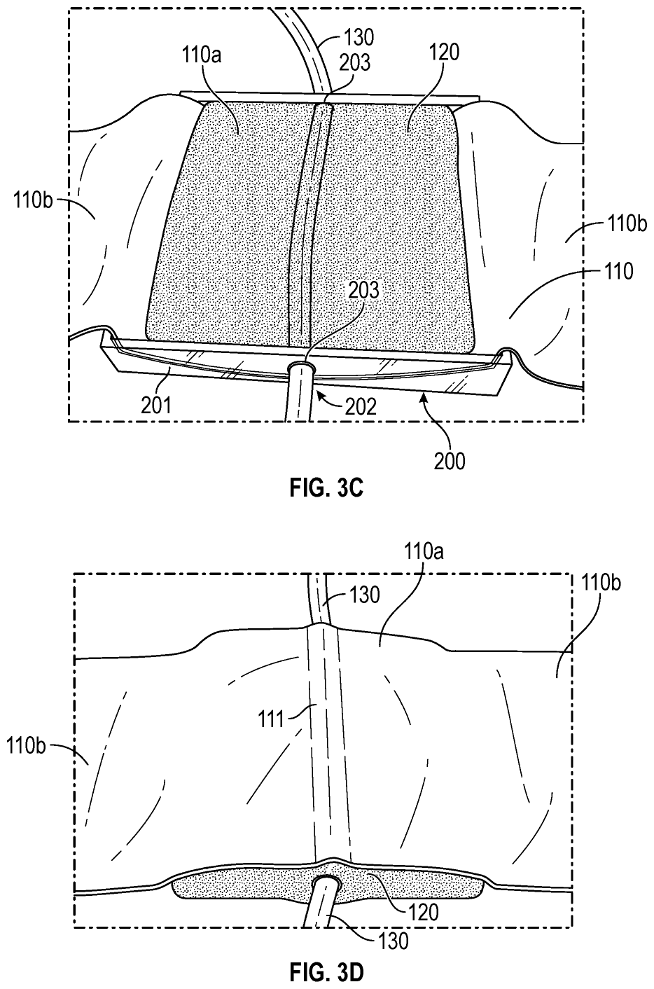

FIGS. 3A-3D provide an example of how vein simulator 100 can be created using mold 200. In FIG. 3A, simulated skin 110 has been placed in mold 200. For example, simulated skin 110 can have a width that generally matches the width of mold 200 so that a length of simulated skin 110 can lie on inner surface 201. In some embodiments, the total length of simulated skin 110 can be greater than the length of mold 200 so that the opposing ends of simulated skin 110 extend out from mold 200.

In FIG. 3B, simulated vein 130 has been inserted through openings 203 so that it is positioned over simulated skin 110 and in alignment with channel 202. In some embodiments, other simulated veins, or a branch from simulated vein 130, could be positioned at this step. For example, one or more additional openings 203 could be included in mold 200 to allow a separate simulated vein to be embedded in simulated tissue 120 or to allow a branch to be spliced into simulated vein 130.

In FIG. 3C, simulated tissue 120 has been poured into mold 200 on top of simulated skin 110 and at least partially surrounding simulated vein 110. In this embodiment, simulated tissue 120 will be positioned on top of an inner section e of simulated skin 110 but not on end portions 110b of simulated skin 110. Also, because openings 203 are spaced above channel 202, simulated tissue 120 will be positioned between simulated skin 110 and simulated vein 130. In other words, simulated tissue 120 will be positioned on top of the portion of simulated skin 110 that is in channel 120, which portion will form protruding vein channel 111.

In FIG. 3D, simulated tissue 120 has hardened and formed an integral bond with simulated skin 110. The now-formed vein simulator 100 has been removed from mold 200 and inverted so that simulated skin 110 faces upward. Due to channel 120, protruding vein channel 111 is formed in simulated skin 110. Also, simulated vein 130 is positioned below protruding vein channel 111 and is spaced to the desired depth from simulated skin 110. Due to inner surface 201, simulated skin 110 has a curved shape that generally resembles the underside of the human forearm. Also, simulated tissue 120 is not adhered to end portions 110b of simulated skin 110 and therefore end portions 110b can be used to secure vein simulator 100 to manikin 200. For example, hook and loop, an adhesive, Velcro or another type of fastener could be positioned on end portions 110b to allow end portions 110b to be secured together and/or to manikin 200 when vein simulator 100 is wrapped around manikin 200.

Because simulated skin 110 is integrated into (or adhered to) simulated tissue 120, including along protruding vein channel 111, and because simulated vein 130 is embedded in simulated tissue 120, there will be no slipping or sliding of simulated skin 110 relative to simulated tissue 120 or simulated vein 130 when a clinician inserts a PIVC into vein simulator 100. Therefore, the responsiveness of vein simulator 100 to the insertion of a PIVC will more closely resemble the responsiveness of human skin, tissue and veins. Also, because simulated skin 110 forms protruding vein channel 111, the clinician will be better able to visualize and find simulated vein 130.

In some embodiments, simulated vein 130 may be connected to a pump or other fluid source that can cause simulated blood to flow through or be pressurized within simulated vein 130. In some embodiments, simulated vein 130 may include or be connected to a septum, valve or other flow obstructing material or device to create simulated valves.

In use, vein simulator 100 can provide better training for clinicians for the complete PIVC workflow. For example, the clinician can rely on protruding vein channel 111, and possibly the anatomical landmarks that manikin 200 provides, to practice identifying the proper location for inserting the PIVC. The clinician can then clean and prepare simulated skin 110 at the identified insertion site in the same manner as the clinician would on a human. As the clinician inserts the PIVC, simulated skin 110, simulated tissue 120 and simulated vein 130 will provide realistic feel and feedback, particularly because simulated skin 110, simulated tissue 120 and simulated vein 130 will move and respond in unison given their integration. Once the clinician has placed the PIVC, he or she can secure it to simulated skin 110 in the same manner as the clinician would on a human.

In some embodiments, vein simulator 100 may also include one or more cameras or other sensors for providing real-time feedback during the insertion of the PIVC. In such embodiments, vein simulator 100 may include or be integrated with a control system such as a computer for controlling the sensors and any electronic components with which they may be used. Such a control system could also be used to power a pump that is connected to simulated vein 130 to ensure that fluid pressure and fluid flow within simulated vein 130 matches a desired blood pressure and rate of blood flow.

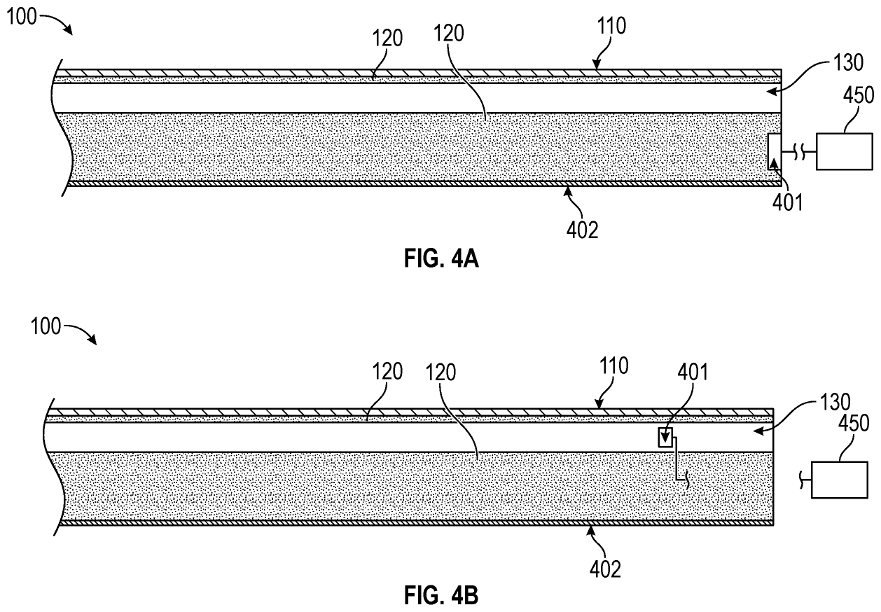

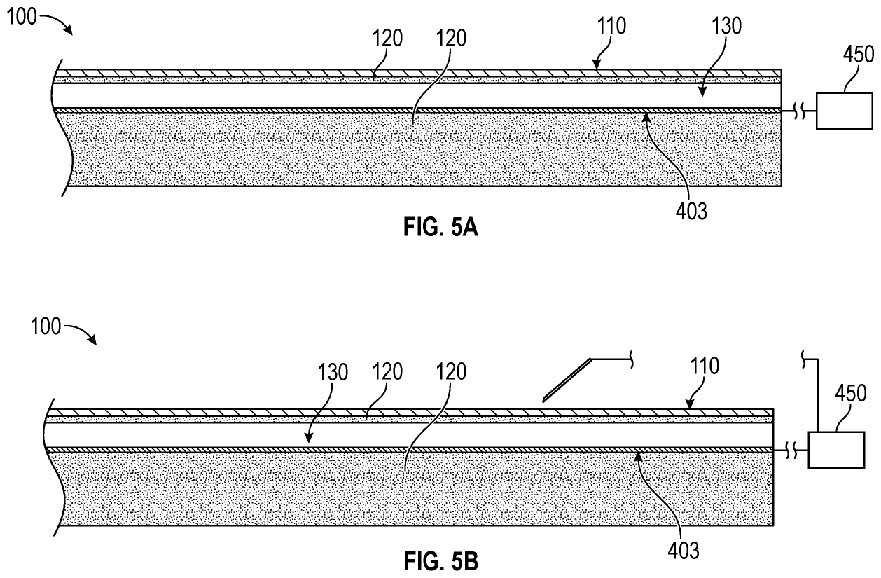

FIGS. 4A-5B provide examples of how vein simulator 100 may be used with one or more sensors. In FIG. 4A, vein simulator 100 includes a camera 401 and a light source 402 that are embedded into or adjacent to simulated tissue 120 and a control system 450 for controlling these components. For example, light source 402 may be positioned under or within simulated tissue 120 to illuminate simulated tissue 120 during the PIVC insertion process. In some embodiments, light source 402 may be in the form of an LED strip. In some embodiments, light source 402 may extend along the full length of simulated tissue 120 or along a portion of the length of simulated tissue 120 (e.g., under an intended insertion site).

By illuminating simulated tissue 120, camera 401 may be enabled to capture video of simulated tissue 120 and simulated vein 130 while a clinician practices placing a PIVC. In some embodiments, control system 450 may be connected to a display device to thereby output video from camera 401 to the display device. Accordingly, the clinician can watch the video on the display device as he or she attempts to place the PIVC. For example, the video enables the clinician to see the position of the distal tip of the needle as it pierces simulated skin 110, passes through simulated tissue 120 and pierces simulated vein 130.

By viewing the video, whether during or after placing the PIVC, the clinician can learn whether he or she successfully placed the PIVC. For example, the visual feedback that camera 401 provides can help the clinician learn when the distal tip of the needle has reached the proper position within simulated vein 130. This can assist the clinician, not only in initially piercing simulated vein 130, but in avoiding contacting or piercing the sidewall of simulated vein 130 after the needle is within simulated vein 130.

In FIG. 4A, camera 401 is positioned at the edge of simulated tissue 120. Various other positions and/or configurations of camera 401 within or against simulated tissue 120 may also be employed in embodiments of the present disclosure. For example, camera 401 could be placed in any suitable location within simulated tissue 120 and oriented towards the intended insertion area such as to the side of simulated vein 130 to capture a view that is perpendicular to the length of simulated vein 130. In other examples, camera 401 may be positioned above or below simulated vein 130 and may capture a view that aligns with the length of simulated vein 130.

FIG. 4B provides an example where camera 401 is positioned within simulated vein 130. In such cases, camera 401 may be positioned upstream or downstream of the intended insertion area. In some embodiments, multiple cameras 401 may be used and may be positioned and/or oriented in a variety of ways to thereby capture a variety of views of the insertion area.

FIGS. 5A and 5B provide examples where vein simulator 100 includes a sensor 403 that is contained in, on or adjacent to simulated vein 130. In FIG. 4A, sensor 403 may be in the form of a film that lines the sidewall of simulated vein 130, is embedded in the sidewall of simulated vein 130 or is sufficiently near the sidewall of simulated vein 130 to detect a change in an electrical property (e.g., capacitance) that a needle of a PIVC may invoke when it approaches or contacts the film. For example, sensor 403 could be a capacitive film that generates a signal that represents the proximity of the needle (e.g., by changing it capacitance relative to the proximity). Sensor 403 could provide such a signal to control system 450. Control system 450 could process the signal to determine the proximity of the needle and/or to determine when the needle has contacted sensor 403.

Control system 450 may include a feedback component by which control system 450 outputs feedback. For example, the feedback component could be a speaker that outputs audio feedback. In such cases, control system 450 could cause the feedback component to output a sound when the signal from sensor 403 indicates that the needle has contacted sensor 403. Similarly, control system 450 could cause the feedback component to output a sound when the signal from sensor 403 indicates that the needle is approaching sensor 403 and may vary this sound (e.g., its pitch or volume) as the needle gets closer to sensor 403. The clinician can rely on such sound(s) to learn when the needle has reached the correct position for proper placement of the PIVC and/or to learn to avoid contacting the sidewall of simulated vein 130.

As another example, feedback component could be a visual feedback component such as one or more LEDs or even a display device. In such cases, control system 450 could cause a visual feedback to be output to the feedback component to represent when the needle has contacted sensor 403 and/or to represent the current proximity of the needle to sensor 403. For example, if the feedback component is an LED, control system 450 could cause the LED to flash at quicker intervals as the needle approaches sensor 403. As another example, control system 450 could generate and update a visual representation of the needle's position relative to the sidewall of simulated vein 130 based on the signal received from sensor 403 and provide the visual representation to the feedback component for display to the clinician (e.g., via a display device). Any other reasonable type of feedback component could also be used.

FIG. 5B is a variation in which sensor 403 forms part of a circuit that is completed when the needle contacts sensor 403. In particular, the needle and sensor 403 may be connected to control system 450 which can detect when the needle contacts sensor 403 due to a change in current and/or voltage that this contact causes. In such embodiments, control system 450 may use a feedback component as described above to present feedback to the clinician.

In embodiments of the present disclosure, a vein simulator may employ any one or more of the above-described types of sensors and feedback to assist a clinician in learning to properly place a PIVC. For example, in addition to camera 401, vein simulator 100 may include sensor 403 to better notify the clinician when he or she contacts the sidewall of simulated vein 130.

In some embodiments, control system 450 may be configured to store the feedback that it generates so that it may be subsequently reviewed and/or scored. For example, control system 450 may maintain a log of a clinician's attempts to place a PIVC using vein simulator 100. In such cases, control system 450 (or an external system) could use the log to create a score for the clinician. Such a score could represent whether each particular attempt was successful, an extent to which each particular attempt was successful, an average success rate, a success trend or any other measurement of success.

In embodiments where multiple sensors are employed, control system 450 may be configured to create associations between feedback from the different sensors. For example, control system 450 may employ a video time code to associate feedback from sensor 403 with the video. Such associations could enable the clinician to determine, while watching the video, exactly when the needle contacted the sidewall of simulated vein 130.

Because simulated skin 110 may be opaque, it may resemble human skin in that it prevents a clinician from seeing the PIVC while inserting it into simulated vein 130. Yet, because simulated tissue 120 can be transparent, the clinician may still rely on camera 401 to ensure that he or she is practicing the placement of the PIVC correctly. After a clinician has become confident that he or she can place a PIVC correctly, he or she may turn of camera 401 or otherwise avoid viewing the captured video to continue practicing. In this way, vein simulator 100 can assist the clinician in quickly developing his or her skills while not becoming dependent on a video to perform proper PIVC placement.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed:

1. A vein simulator comprising:
simulated skin;
simulated tissue into which the simulated skin is integrated; and
one or more simulated veins that are embedded into the simulated tissue.

2. The vein simulator of claim 1, wherein the simulated skin is leather, artificial leather, or another human skin analogue.

3. The vein simulator of claim 1, wherein the simulated tissue is a ballistic material, medical gel, or another gel.

4. The vein simulator of claim 1, wherein the one or more simulated veins are a tubular elastomeric material.

5. The vein simulator of claim 1, wherein the simulated skin is integrated into the simulated tissue by causing the simulated tissue to solidify while in contact with the simulated skin.

6. The vein simulator of claim 1, wherein the simulated skin includes a protruding vein channel.

7. The vein simulator of claim 6, wherein a first simulated vein of the one or more simulated veins extends along the protruding vein channel.

8. The vein simulator of claim 1, wherein an inner section of the simulated skin is integrated into the simulated tissue and end portions of the simulated skin are not integrated into the simulated tissue.

9. The vein simulator of claim 8, wherein the end portions of the simulated skin include one or more fasteners for interconnecting the end portions.

10. The vein simulator of claim 1, further comprising:
one or more cameras for capturing images or video of the simulated tissue or the one or more simulated veins.

11. The vein simulator of claim 1, further comprising:
one or more sensors for providing feedback indicative of a location of a needle relative to the one or more simulated veins.

12. A method for creating a vein simulator comprising:
obtaining a mold;
positioning a simulated skin in the mold;
positioning one or more simulated veins in the mold overtop the simulated skin; and
adding simulating tissue to the mold on top of the simulated skin.

13. The method of claim 12, wherein positioning the one or more simulated veins in the mold overtop the simulated skin comprises inserting a first simulated vein of the one or more simulated veins through openings in the mold.

14. The method of claim 12, wherein the simulated skin is positioned in the mold on an inner surface and the inner surface includes a channel for forming a protruding vein channel in the simulated skin.

15. The method of claim 14, wherein the inner surface is curved.

16. The method of claim 12, further comprising:
positioning one or more cameras in or against the simulated tissue.

17. A vein simulator comprising:
simulated skin that is formed of leather, artificial leather or another human skin analogue;
simulated tissue that is formed of a ballistic material, medical gel or another gel, the simulated skin being integrated into the simulated tissue; and
a simulated vein that is embedded in the simulated tissue.

18. The vein simulator of claim 17, wherein the simulated skin and the simulated tissue form a protruding vein channel and the simulated vein extends along the protruding vein channel.

19. The vein simulator of claim 17, wherein the simulated skin is configured to secure the vein simulator to a manikin.

20. The vein simulator of claim 17, further comprising:
one or more cameras for capturing images or videos inside the vein simulator.
